(19) United States
(12) Patent Application Publication
(10) Pub. No.: US 2014/0134581 A1
(43) Pub. Date: May 15, 2014

(54) ASSESSMENT FOR IDENTIFYING DERAILERS OF INTERPERSONAL BEHAVIOR

(71) Applicants: Robert Travis Hogan, (US); HOGAN ASSESSMENT SYSTEMS, INC., Tulsa, OK (US)

(72) Inventors: Robert Travis Hogan, Fernandina Beach, FL (US); Joyce Cummings Hogan, Fernandina, FL (US)

(73) Assignee: Hogan Assessment Systems, Inc., Tulsa, OK (US)

(21) Appl. No.: 13/673,175

(22) Filed: Nov. 9, 2012

(51) Int. Cl. G09B 7/00

(52) U.S. Cl. CPC G09B 7/00
USPC 434/236

(57) ABSTRACT

An assessment is provided to identify an individual's derailers of interpersonal behavior and provide a fine-grained analysis of the identified derailers. The assessment provides a score for a number of potentially negative aspects, i.e., derailers, where each aspect is represented as a scale. A subscale structure provides additional insights about specific facets of potentially negative behavior related to each aspect. The assessment provides scores for the subscale facets to illustrate the facets most contributing to the respective potentially negative aspect of interpersonal behavior. An elevated subscale score serves as an indication that the individual is at risk for the respective facet.

### TECHNOLOGY FIELD

The present invention relates generally to an assessment, and more particularly to an assessment to identify an individual's personality-based performance risks and derailers of interpersonal behavior.

### BACKGROUND

Various entities, such as corporations and other organizations, utilize assessments to measure certain aspects, such as personality dimensions, relating to employees or potential employees. For example, the Five-Factor Model of personality is widely-employed in psychological assessment to determine an individual's openness, conscientiousness, extraversion, agreeableness, and emotional stability.

It is desirable to identify personality-based performance risks and derailers of interpersonal behavior, which affect an individual's leadership style and actions. For example, being able to proactively recognize an individual's risks/derailers allows professionals to mitigate them through development and coaching. It is also desirable to provide insights about specific facets of behavior related to each risk/derailer.

This document describes an assessment that identifies derailers of interpersonal behavior and provides a fine-grained analysis of the identified derailers.

### SUMMARY

Embodiments of the present invention provide an assessment for identifying aspects of interpersonal behavior of an individual.

According to an embodiment, a method of identifying aspects of interpersonal behavior of an individual includes presenting the individual with a plurality of assessment items relating to interpersonal behavior; receiving a plurality of answers, each answer of the plurality of answers corresponding to one of the plurality of assessment items; and determining, based on the plurality of answers, a multi-level representation of the interpersonal behavior of the individual, wherein the multi-level representation comprises (i) a plurality of scale scores, each scale score corresponding to a respective one of a plurality of scales; and (ii) a plurality of subscale scores, each subscale score corresponding to a respective one of a plurality of subscales; wherein each of the plurality of scales describes a respective aspect of interpersonal behavior and comprises a subset of the plurality of subscales that further define the respective aspect of interpersonal behavior.

In an embodiment, the plurality of scale scores and the plurality of subscale scores indicate propensities of the individual to the respective aspects of interpersonal behavior.

Determining the multi-level representation may include, according to an embodiment, determining each of the plurality of subscale scores by, for each of the plurality of subscales, summing answers to a subset of the plurality of assessment items that correspond to the respective subscale.

Determining the multi-level representation may further include, according to an embodiment, determining each of the plurality of scale scores by, for each of the plurality of scales, totaling the plurality of subscale scores of the respective subset of the plurality of subscales.

In an embodiment, each of the plurality of answers corresponds to a zero or a one.

In an embodiment, each of the plurality of items comprises a true/false item.

In an embodiment, the multi-level representation comprises one or more profiles, each of the one or more profiles based on the plurality of scale scores and the plurality of subscale scores.

Determining the multi-level representation may also include, according to an embodiment, selecting the one or more profiles from a pre-established selection of profiles, wherein each of the pre-established selection of profiles is based on a range of applicable scale scores and applicable subscale scores.

In an embodiment, each of the plurality of assessment items corresponds to one of the plurality of subscales and one of the plurality of scales.

In additional embodiments, a method and a system are provided for implementing an assessment to identify potentially negative aspects of interpersonal behavior of an individual, by presenting the individual with a plurality of assessment items relating to potentially negative interpersonal behavior; receiving a plurality of answers, each answer of the plurality of answers corresponding to one of the plurality of items; and determining, based on the plurality of answers: (i) a plurality of subscale scores, each subscale score corresponding to a respective one of a plurality of subscales and comprising a sum of a subset of answers whose respective items correspond to the respective subscale; and (ii) a plurality of scale scores, each scale score corresponding to a respective one of a plurality of scales and comprising a sum of a subset of subscale scores whose respective subscales correspond to the respective scale. Each of the plurality of scales describes a respective potentially negative aspect of interpersonal behavior and comprises a subset of the plurality of subscales that further define the respective potentially negative aspect of interpersonal behavior.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram depicting a multi-level representation of the interpersonal behavior of an individual, according to an embodiment;

FIG. 2 shows a system for administering an assessment and identifying aspects of the interpersonal behavior of an individual, according to an embodiment;

FIGS. 3A, 3B, and 3C are diagrams of example reports illustrating the multi-level representation of the interpersonal behavior of individuals who have completed an assessment, according to an embodiment;

FIG. 4 shows a flowchart of a method of taking an assessment, according to an embodiment;

FIGS. 5A and 5B are flowcharts of a method of identifying aspects of the interpersonal behavior of an individual, according to embodiments; and

FIGS. 6A and 6B are diagrams illustrating a scoring process used to identify aspects of the interpersonal behavior of an individual.

### DETAILED DESCRIPTION OF ILLUSTRATIVE EMBODIMENTS

Embodiments of the present invention relate to an assessment taken by an individual to identify derailers (also referred to herein as potentially negative aspects or aspects) of interpersonal behavior and provide a fine-grained analysis of the identified derailers.

Embodiments of the present invention are particularly well suited for, but in no way limited to, organizations desiring to obtain information relating to aspects, such as potentially negative aspects, of interpersonal behavior of job applicants to avoid hiring individuals with certain derailers, or incumbent employees to mitigate the identified aspects through coaching or other developmental activities.

The potentially negative aspects of interpersonal behavior may be considered as strengths under normal circumstances; but these supposed strengths may impede effectiveness in certain situations (careers, relationships, education, etc.) when the individual is tired, pressured, bored, distracted, or otherwise lacking social vigilance. The assessment, according to embodiments provided herein, provides scores for a number of potentially negative aspects (where each aspect is represented as a scale), and an elevated score may serve as an indication that the individual is at risk for derailment on the particular aspect.

A subscale structure provides additional insights about specific facets of potentially negative behavior related to each aspect. For example, rather than simply providing a score for a particular aspect, the assessment provided herein provides a number of subscale scores for the particular aspect to explain underlying facets that contribute to the particular aspect. The assessment provides scores for the subscale facets to illustrate the facets most contributing to the respective aspect (i.e., risk or derailer). An elevated subscale score serves as an indication that the individual is at risk for the respective facet of potentially negative interpersonal behavior.

Table 1 provides a list of potentially negative aspects of interpersonal behavior, including subscale components corresponding to each aspect. The aspects and subscales provided in Table 1 comprise an account of the risks/derailers accounted by the assessment methodology provided herein according to one embodiment. In additional embodiments, other aspects and subscales may be used with the assessment methodology.

TABLE 1

| Aspect and Subscale | Definition |
|---|---|
| Excitable: Volatile | Moody, easily angered or annoyed, and bothered by little |
| | things. |
| Excitable: Easily Disappointed | Enthusiastic about people/things in the short-term but |
| | easily disappointed and hard to please. |
| Excitable: No Direction | Lacking strength in personal beliefs or interests, with |
| | regrets about the past. |
| Skeptical: Cynical | Quickly doubtful of others' true intentions and assuming |
| | ulterior motives. |
| Skeptical: Mistrusting | Lacking a general sense of trust in people and institutions; |
| | alert for signs of perceived mistreatment. |
| Skeptical: Grudges | Holding grudges and lacking forgiveness about real or |
| | perceived prior wrongs. |
| Cautious: Avoidant | Avoiding new people and situations because of a general |
| | awkwardness. |
| Cautious: Fearful | Afraid to act because of fear of making mistakes and |
| | being judged or criticized. |
| Cautious: Unassertive | Reluctant to assert or stand up for oneself and prone to |
| | being taken advantage of. |
| Reserved: Introverted | Preferring to work and spend time alone rather than with |
| | others. |
| Reserved: Unsocial | Keeping people at a distance, limiting close relationships |
| | and being generally detached. |
| Reserved: Tough | Disinterested in the feelings and problems of others, |
| | focusing on tasks rather than people. |
| Leisurely: Passive Aggressive | Publicly compliant and pleasant but privately resentful of |
| | others. |
| Leisurely: Unappreciated | Feeling that one's contributions, effort, and outcomes are |
| | unrecognized and perceiving inequities in workload. |
| Leisurely: Irritated | Frequently irritated by interruptions or others' requests or |
| | input. |
| Bold: Entitled | Feeling deserving of special treatment because of |
| | perceived achievements and personal importance. |
| Bold: Overconfidence | Unusually self-confident in one's perceived abilities to |
| | succeed at anything attempted. |
| Bold: Fantasized Talent | Holding opinions that one has innate and exceptional |
| | talents and gifts or being born for greatness. |
| Mischievous: Risky | Prone to taking ill-advised risks and testing limits, taking |
| | enjoyment in bending or breaking the rules. |
| Mischievous: Impulsive | Spontaneously acting on instinct and following temporary |
| | impulses. |
| Mischievous: Manipulative | Using charm, acting, or otherwise manipulating others to |
| | reach desired goals. |
| Colorful: Public Confidence | Unusually interested in being the center of attention |
| | through public speaking or other expressive action. |
| Colorful: Distractible | Quickly bored with details, enjoying multiple activities; |
| | confusing activity with production. |
| Colorful: Self-Display | Seeking attention by showing off and using dramatic self- |
| | expression to stand out from others. |
| Imaginative: Eccentric | Being unusually unconventional and idiosyncratic in |
| | thoughts and ideas. |
| Imaginative: Special Sensitivity | Believing one has special abilities to notice the otherwise |
| | overlooked and read people. |
| Imaginative: Creative Thinking | Being unusually creative or ahead of one's time in using |
| | imagination to creatively solve problems. |
| Diligent: Standards | Having exceptionally high standards for oneself and |
| | others in terms of work performance. |
| Diligent: Perfectionistic | Perfectionistic about work and attending to all possible |
| | details. |
| Diligent: Organized | Meticulous and inflexible about schedules, timing, and |
| | rules and procedures. |
| Dutiful: Indecisive | Overly reliant on others for guidance in making decisions |
| | and reluctant to act independently. |
| Dutiful: Ingratiating | Overly eager to please one's superiors, telling them what |
| | they want to hear and avoiding criticism. |
| Dutiful: Conforming | Taking pride in supporting superiors and following |
| | direction regardless of personal opinion. |

It is important to note that the subscales further define the respective potentially negative aspects (i.e., scales). The subscale components intrinsically make up the respective aspect, thus identifying the various features of the respective aspect.

For example, with respect to the “Imaginative” aspect, traditional assessments may interpret an individual with a high score on the Imaginative aspect as representing all Imaginative tendencies, including being eccentric and unusually creative and believing one has special abilities to understand things that others cannot. All individuals receiving a high score on the Imaginative scale would be provided with the same characterization. However, with the subscale component, a high Imaginative scale score indicates that the individual may represent some tendencies included in the scale, but not necessarily others. Specifically, the individual may behave in eccentric and unusually creative ways when under stress, but may not believe that they possess special insights. Customized feedback, according to the assessment described herein, may be provided to each participant based on their scores to the subscales as well as the overall scales. Without subscale scores, this information would not be available.

Table 2 provides a comparison between interpretations without the subscale components and with the subscale components, emphasizing the fine-grained detail provided by incorporating the subscale features of the present invention. The interpretations provided in Table 2 are merely examples for illustrative purposes.

TABLE 2

| | High Scale Score without | High Scale Score with |
|---|---|---|
| Aspect | Subscales | Subscales |
| Excitable | A high Excitable scale | A high Excitable scale |
| | score indicates that the | score indicates that the |
| | individual represents ALL | individual may represent |
| | tendencies included in the | some tendencies included in |
| | scale, including being | the scale, but not |
| | moody and emotionally | necessarily others. For |
| | volatile, quick to move | example, the individual |
| | from enthusiasm to | may become easily |
| | disappointment, and lacking | disappointed or emotionally |
| | well-defined beliefs. | volatile when under stress, |
| | | but may possess a core of |
| | | well-defined beliefs and |
| | | interests. |
| Skeptical | A high Skeptical scale score | A high Skeptical scale score |
| | indicates that the individual | indicates that the individual |
| | represents ALL tendencies | may represent some |
| | included in the scale, | tendencies included in the |
| | including being alert for | scale, but not necessarily |
| | signs of perceived | others. For example, the |
| | mistreatment, doubting | individual may remain alert |
| | others' intentions, and | for signs of perceived |
| | holding grudges. | mistreatment and hold |
| | | grudges, but may not |
| | | assume ulterior motives in |
| | | others' actions. |
| Cautious | A high Cautious scale score | A high Cautious scale score |
| | indicates that the individual | indicates that the individual |
| | represents ALL tendencies | may represent some |
| | included in the scale, | tendencies included in the |
| | including being avoidant, | scale, but not necessarily |
| | fearful of criticism, and | others. For example, the |
| | unassertive. | individual may behave in a |
| | | fearful and unassertive |
| | | manner when under stress, |
| | | but may not avoid new |
| | | people and situations. |
| Reserved | A high Reserved scale score | A high Reserved scale score |
| | indicates that the individual | indicates that the individual |
| | represents ALL tendencies | may represent some |
| | included in the scale, | tendencies included in the |
| | including being introverted, | scale, but not necessarily |
| | unsocial, and insensitive to | others. For example, the |
| | others' problems. | individual may become |
| | | more introverted and |
| | | unsocial when under stress, |
| | | but may actually be highly |
| | | sensitive to others' |
| | | problems. |
| Leisurely | A high Leisurely scale | A high Leisurely scale |
| | score indicates that the | score indicates that the |
| | individual represents ALL | individual may represent |
| | tendencies included in the | some tendencies included in |
| | scale, including being | the scale, but not |
| | passive aggressive, | necessarily others. For |
| | perceived as unappreciated, | example, the individual |
| | and privately resentful. | may react to stress in |
| | | passive aggressive or |
| | | privately resentful ways, |
| | | but may also feel that their |
| | | contributions at work are |
| | | recognized and appreciated. |
| Bold | A high Bold scale score | A high Bold scale score |
| | indicates that the individual | indicates that the individual |
| | represents ALL tendencies | may represent some |
| | included in the scale, | tendencies included in the |
| | including being arrogant, | scale, but not necessarily |
| | entitled, and believing that | others. For example, the |
| | one has unusual talents and | individual may behave in an |
| | gifts. | arrogant and entitled |
| | | manner when under stress, |
| | | but may not believe that |
| | | they are destined for |
| | | greatness because of |
| | | unusual gifts. |
| Mischie- | A high Mischievous scale | A high Mischievous scale |
| vous | score indicates that the | score indicates that the |
| | individual represents ALL | individual may represent |
| | tendencies included in the | some tendencies included in |
| | scale, including being risk- | the scale, but not |
| | taking, impulsive and | necessarily others. For |
| | spontaneous, and | example, the individual |
| | manipulative of others. | may behave in a risky and |
| | | impulsive manner when |
| | | under stress, but may be |
| | | unlikely to manipulate |
| | | others in these situations. |
| Colorful | A high Colorful scale score | A high Colorful scale score |
| | indicates that the individual | indicates that the individual |
| | represents ALL tendencies | may represent some |
| | included in the scale, | tendencies included in the |
| | including being excessively | scale, but not necessarily |
| | dramatic, easily distracted, | others. For example, the |
| | and seeking others' | individual may behave in a |
| | attention. | dramatic and attention- |
| | | seeking manner when under |
| | | stress, but may be unlikely |
| | | to become distracted in |
| | | these situations. |
| Imagi- | A high Imaginative scale | A high Imaginative scale |
| native | score indicates that the | score indicates that the |
| | individual represents ALL | individual may represent |
| | tendencies included in the | some tendencies included in |
| | scale, including being odd | the scale, but not |
| | and eccentric, unusually | necessarily others. For |
| | creative, and believing that | example, the individual |
| | one has special abilities to | may behave in eccentric |
| | understand things that | and unusually creative ways |
| | others cannot. | when under stress, but may |
| | | not believe that they |
| | | possess special insights. |
| Diligent | A high Diligent scale score | A high Diligent scale score |
| | indicates that the individual | indicates that the individual |
| | represents ALL tendencies | may represent some |
| | included in the scale, | tendencies included in the |
| | including being | scale, but not necessarily |
| | perfectionistic, meticulous, | others. For example, the |
| | and having exceptionally | individual may be |
| | high standards for oneself | perfectionistic and |
| | and others. | meticulously organized |
| | | when under stress, but may |
| | | hold realistic standards for |
| | | oneself and others. |
| Dutiful | A high Dutiful scale score | A high Dutiful scale score |
| | indicates that the individual | indicates that the individual |
| | represents ALL tendencies | may represent some |
| | included in the scale, | tendencies included in the |
| | including being indecisive, | scale, but not necessarily |
| | ingratiating to one's | others. For example, the |
| | superiors, and excessively | individual may behave in |
| | conforming. | excessively conforming and |
| | | ingratiating ways when |
| | | under stress, but may have |
| | | no problems making |
| | | independent decisions in |
| | | these situations. |

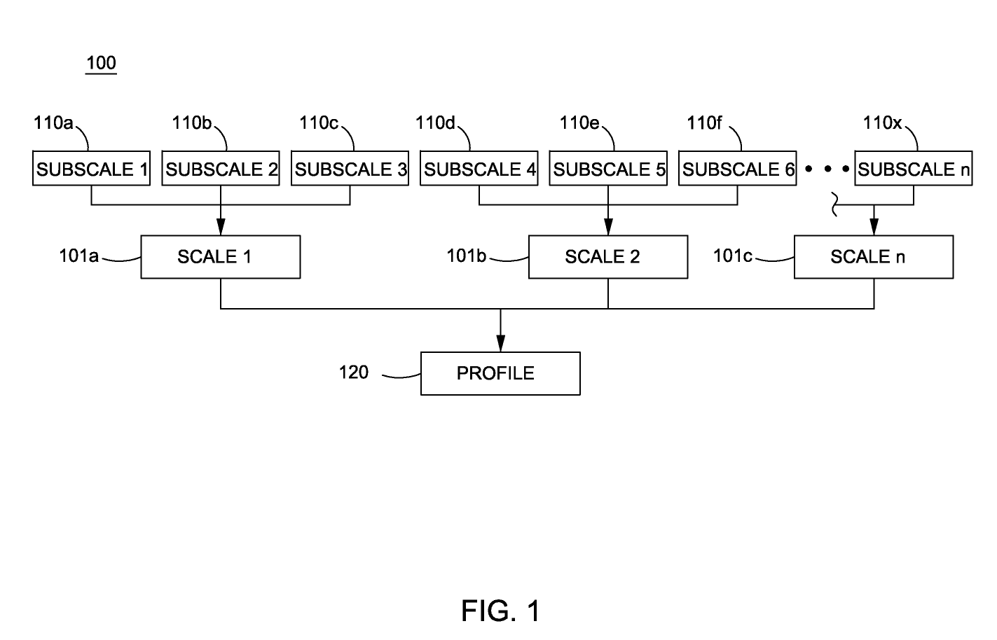

FIG. 1 is a diagram depicting a multi-level representation 100 of the potentially negative interpersonal behavior of an individual, according to an embodiment. The multi-level representation 100 includes scales 101 and subscales 110 that, together with corresponding scores as further described below, are the result of an individual having taken the assessment provided herein. Shown are scale 1 (101a), scale 2 (101b), and scale n (101c) with respective subscales 1 (110a), 2 (110b), and 3 (110c) corresponding to scale 1 (101a); subscales 4 (110d), 5 (110e), and 6 (110f) corresponding to scale 2 (101b); and subscale n (110x). According to one embodiment, there are 11 scales 101, each with three subscales 110. In other embodiments, various numbers and combinations of subscales 110 and scales 101 may be implemented as part of the assessment. The assessment may be customized and adapted to fit the requirements of various organizations. For example, an organization may be interested or focused on a particular group of scales 101 and, within the particular group of scales 101, a particular subset of subscales 110.

According to additional embodiments, the multi-level representation 100 may be associated with one or more profiles 120, thus adding another layer to the multi-level representation 100. The profiles 120 are based on the scores of the scales 101 and the scores of the subscales 110 and serve to define or further characterize the associated multi-level representation 100. According to an embodiment, one profile 120 is associated with the scores of the scales 101 and the scores of the subscales 110, thus providing a comprehensive viewpoint of the potentially negative interpersonal behavior of an individual. According to an embodiment, one profile 120 may be associated with a specific subset of the scales 101 and the corresponding subscales 110, to reflect aspects that are of most interest or importance to an organization for which the assessment is being taken. In other embodiments, the multi-level representation 100 may be associated with more than one profile 120. For example, a first profile 120 may correspond to a first subset of scales 101 and the corresponding subscales 110, while a second profile 120 corresponds to a second subset of scales 101 and the corresponding subscales 110.

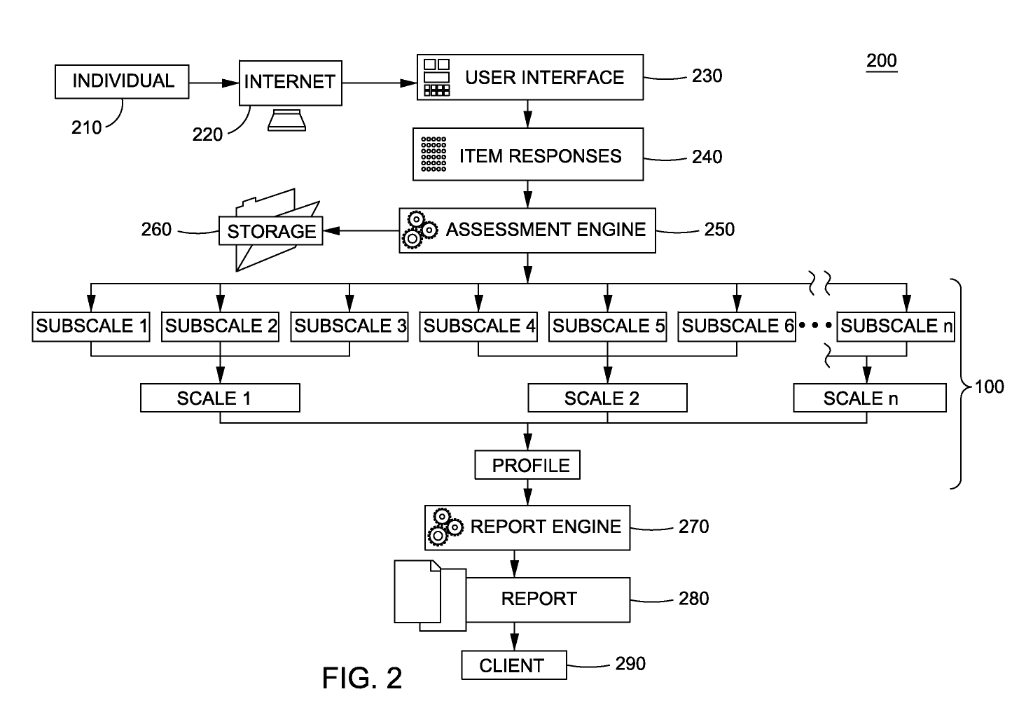

FIG. 2 shows a system 200 for administering an assessment and identifying potentially negative aspects of the interpersonal behavior of an individual, according to an embodiment. The assessment includes a series of items presented to an individual 210. The items may be statements to which the individual 210 answers “true” or “false”. In another embodiment, the items may be questions to which the individual 210 answers “yes” or “no”. In yet another embodiment, the items may be questions or statements with multiple choice answers. The items may also be a combination of the above. The items may relate to how the individual 210 feels and/or behaves with respect to various environments, people, challenges, and other issues. The individual 210 is presented with the series of items on a user interface 230 by way of a network connection, such as the Internet 220. Via the user interface 230, item responses 240 (e.g., True/False or Yes/No responses to the items) from the individual 210 are gathered. An assessment engine 250 processes the item responses 240 and generates the multi-level representation 100 with scales 101 and subscales 110 for the particular individual 210. A report engine 270 processes the multi-level representation 100 into a report 280, which is provided to a client 290 (or other entity such as the individual 210).

Information relating to how the item responses 240 sum to the scales 101 and the subscales 110 is stored in the data storage 260 and utilized by the assessment engine 250 and/or the report engine 270 to generate the multi-level representation 100 and/or the report 280, as further described below with respect to the scoring process.

A pre-established selection of profiles 120 may be defined and stored in the data storage 260, and each profile 120 may be based on a range of applicable scale scores and applicable subscale scores. For example, if an individual 210 scores within +/−1 point of applicable scale scores and subscale scores for a particular profile 120, the individual 210 may be associated with that particular profile 120. The assessment engine 250 of the system 200 may process the scores to determine the profile 120 that corresponds to the individual 210.

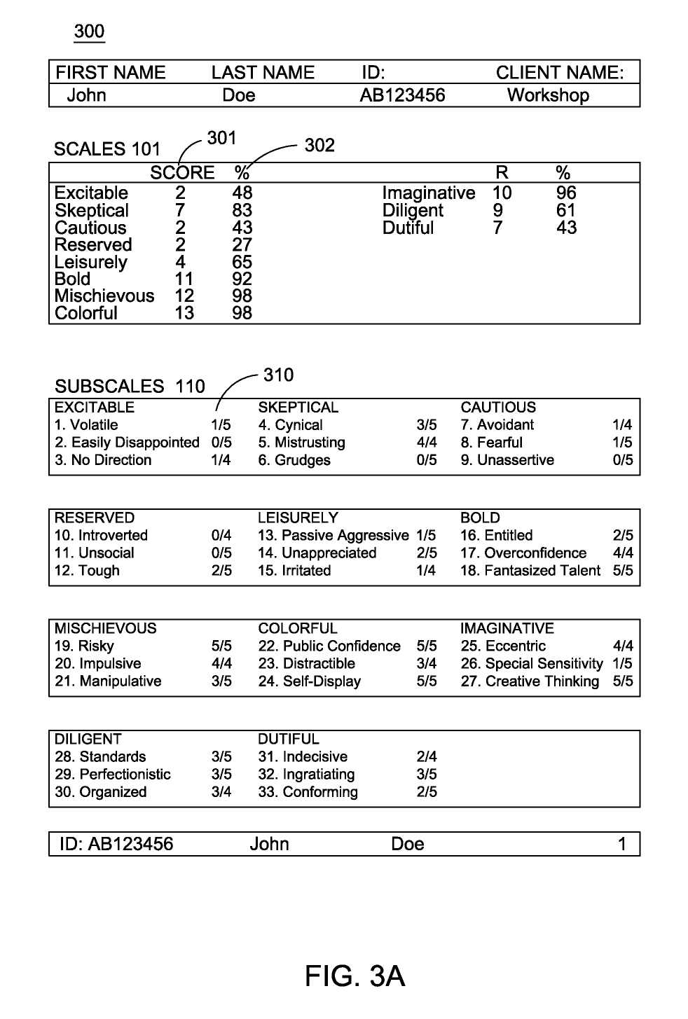

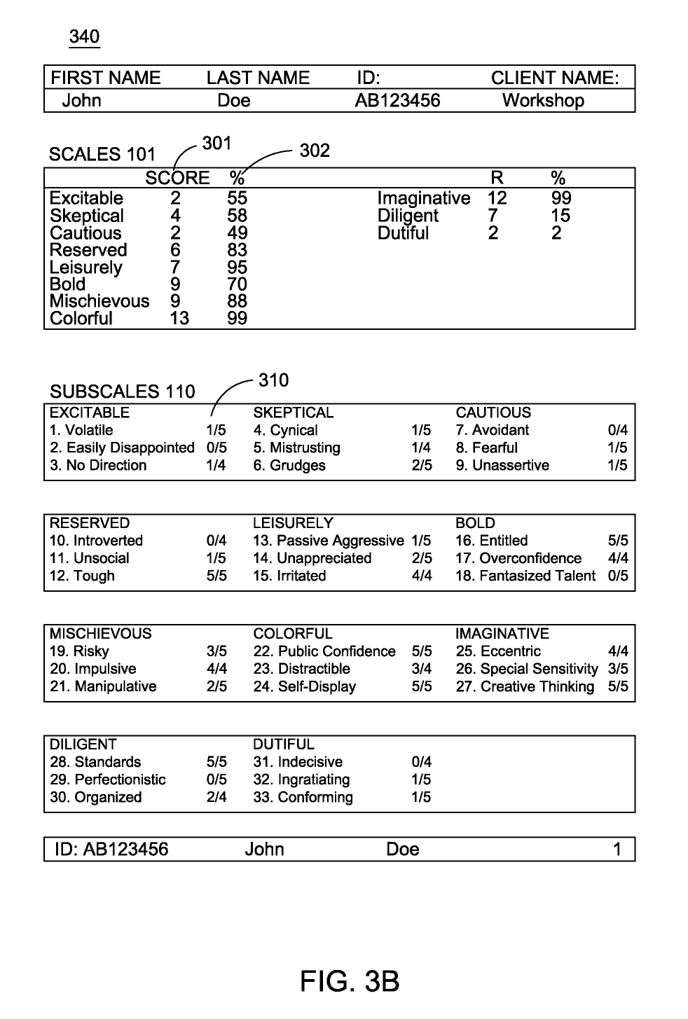

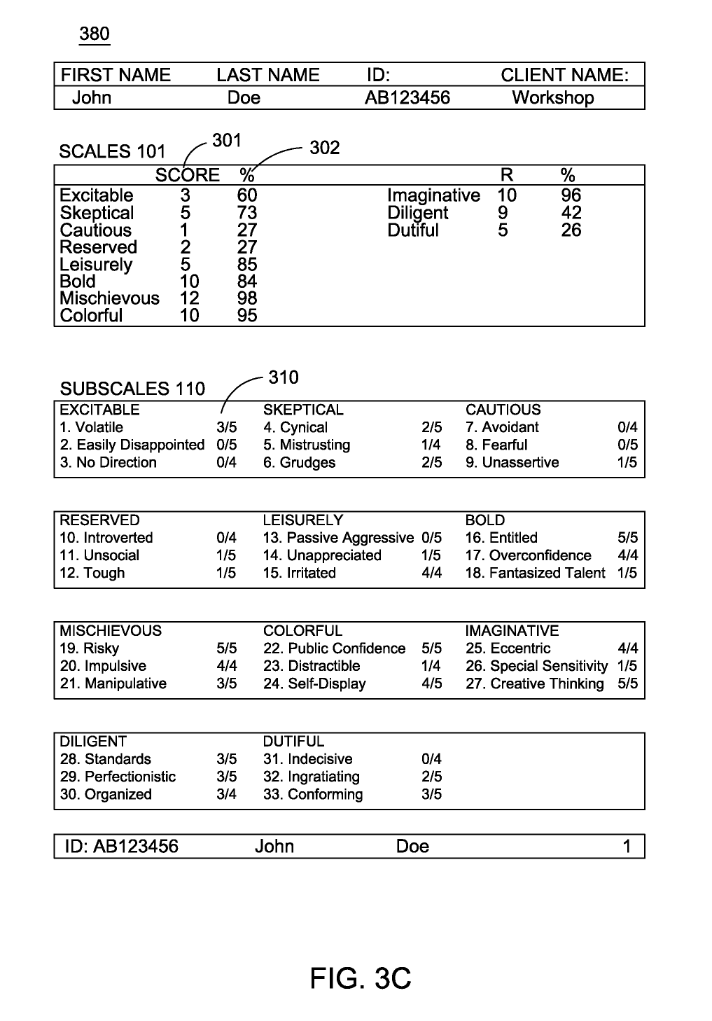

Example reports 300, 340, and 380 are provided in FIGS. 3A, 3B, and 3C, respectively. The example reports 300, 340, and 380 indicate the scales 101 (representing the various aspects of the assessment) with respective raw scale scores 301 and normative percentile ranks 302 for an individual 210. The percentile ranks 302 indicate how the corresponding raw scale scores 301 relate to a normative sample (i.e., where the individual 210 falls with respect to other individuals).

The example reports 300, 340, and 380 also indicate the subscales 110 with respective subscale scores 310. The example reports 300, 340, and 380 correspond to profiles 120a, 120b, and 120c, respectively. Detailed descriptions of the profiles 120a, 120b, and 120c are provided in Table 3.

TABLE 3

| Profile | Description |
|---|---|
| Moving Against | This profile represents a person who is outgoing and insightful |
| (120a) | (Reserved scale, Introverted and Unsocial subscales), self- |
| | dramatizing, exuberant, and attention-seeking (Colorful scale, |
| | Public Confidence and Self-Display subscales), excitement- |
| | seeking and limit-testing (Mischievous scale, Risky and |
| | Impulsive subscales), confident, bright, and charismatic (Bold |
| | scale, Overconfidence and Fantasized Talent subscales), and |
| | creative and innovative (Imaginative scale, Eccentric and |
| | Creative Thinking subscales). There is also a tendency to |
| | distrust others in the organization and to feel exploited by them |
| | (Skeptical scale, Cynical and Mistrusting subscales). |
| | Scores suggest public self-confidence that may obscure private |
| | self-doubt. Not hidden is substantial impulsivity (Mischievous |
| | scale, Impulsive subscale) and arrogance (Bold scale, |
| | Overconfidence subscale) that are most likely to emerge when |
| | this individual is facing a heavy work load or interpersonal |
| | conflict; it is in these “stressful” contexts that his need to |
| | control events by dominating, dazzling, or intimidating others |
| | (the core features of the “moving against” constellation of |
| | behaviors) can be expected to emerge. He will make a strong |
| | impression during an interview, but on a daily basis his noisy |
| | self-promoting tendencies will begin to be resented. For |
| | development, he needs to learn to calm down, listen effectively, |
| | and not be quite so hard on himself. |
| Corporate Guerilla | This is the profile of a person who seems confident and self- |
| (120b) | promoting (Bold scale, Entitled and Overconfidence subscales), |
| | dramatic and attention-seeking (Colorful scale, Public |
| | Confidence and Self-Display subscales), innovative but easily |
| | distracted (Imaginative scale, Eccentric and Creative Thinking |
| | subscales), indifferent to others' needs (Reserved scale, Tough |
| | subscale), decisive (Dutiful scale, Indecisive subscale), and |
| | unconcerned with details (Diligent scale, Perfectionistic |
| | subscale). This person appears self-confident and assertive. |
| | However, he may also be resentful of others (Leisurely scale, |
| | Irritated subscale) and impulsive (Mischievous scale, Impulsive |
| | subscale). |
| | This is a profile of an individual who may present himself as |
| | motivated toward meeting corporate expectations while he |
| | covertly sets his own rules, feels considerable resentment |
| | toward management, fails to consider adequately the |
| | consequences of his actions, and advances his own agenda at |
| | the expense of others. It is the subtle and covert nature of these |
| | actions that lead to the label of a “corporate guerilla.” |
| Fear-Driven Salesman | The most distinctive feature of this profile is the elevation of |
| (120c) | scores in the scales of Bold, Mischievous, Colorful, and |
| | Imaginative. These elevations suggest that this man will seem |
| | outgoing and confident (Bold scale, Entitled and |
| | Overconfidence subscales), risk-taking and impulsive |
| | (Mischievous scale, Risky and Impulsive subscales), dramatic |
| | and entertaining (Colorful scale, Public Confidence and Self- |
| | Display subscales), and unusually creative and eccentric |
| | (Imaginative scale, Eccentric and Creative Thinking subscales). |
| | Scores on other scales and subscales suggest that he is socially |
| | engaged (Reserved scale, Introverted subscale), unconcerned |
| | about others' reactions (Cautious scale, Avoidant and Fearful |
| | subscales), and independent in decision-making (Dutiful scale, |
| | Indecisive subscale). |
| | This pattern is typical of high-powered sales people. Those |
| | who are successful in sales are typically dynamic, charming, |
| | socially skilled, bright, imaginative, and flexible. However, in |
| | addition to these attributes, this man has some fairly strong |
| | private self-doubts. He is likely to be easily irritated by others |
| | at work (Leisurely scale, Irritated subscale), and he is likely to |
| | clash with his supervisors (Excitable scale, Volatile subscale). |

The profiles 120a, 120b, and 120c provided above are purely meant as examples. Various other profiles may be created based on various subsets of scales 101 and subscales 110. Moreover, various other characteristics may be applied to the profiles, depending on, for example, the organization utilizing the assessment.

As illustrated by the example reports 300, 340, and 380 and the corresponding example profiles 120a, 120b, and 120c, the inclusion of the subscales 110 provides a fine-grained description of the corresponding aspects (i.e., scales 101) that is not possible without the subscales 110. For example, consider the Mischievous, Colorful, and Imaginative scales. In the report 300, the raw scale scores 301 are 12, 13, and 10, respectively, and the normative percentile ranks 302 are 98%, 98%, and 96%, respectively. In the report 340, the raw scale scores 301 are 9, 13, and 12, respectively, and the normative percentile ranks 302 are 88%, 99%, and 99%, respectively. In the report 380, the raw scale scores 301 are 12, 10, and 10, respectively, and the normative percentile ranks 302 are 98%, 95%, and 96%, respectively. Based on the raw scale score numbers 301 without the subscales 110, a person reviewing the raw scale scores 301 for each of the reports 300, 340, and 380 would likely reach the conclusion that each of the individuals exhibit all of the behaviors that are considered to be Mischievous, Colorful, and Imaginative. There is an indication that, for example, the individual associated with the report 300 is slightly more Colorful than the individual with the report 380 (raw scale scores 301 of 13 versus 10, respectively). But the numbers alone do not provide any other discerning information about the individuals.

However, with the subscales 110, a person reviewing each of the reports 300, 340, and 380 is provided with a much more detailed explanation into the potentially negative aspects of the individuals. For example, again looking at the Colorful scale for the individuals associated with reports 300 and 380, it can be seen that the individual associated with the report 300 has a propensity for being confident in public and seeking others' attention (scores of 5/5 for Public Confidence and Self-Display subscales 110) and is somewhat distractible (score of 3/4 for Distractible subscale 110). On the other hand, the individual associated with report 380, based on his or her assessment, is not as great an attention seeker (score of 4/5 for Self-Display subscale 110) and is not prone to being distractible (score of 1/4 for Distractible subscale 110).

In addition to the subscales 110 providing a fine-grained analysis of the potentially negative aspects of the individual 210, the profiles 120 provide a representation that may be useful for corporations or organizations seeking to meaningfully utilize the scales 101 and the subscales 110.

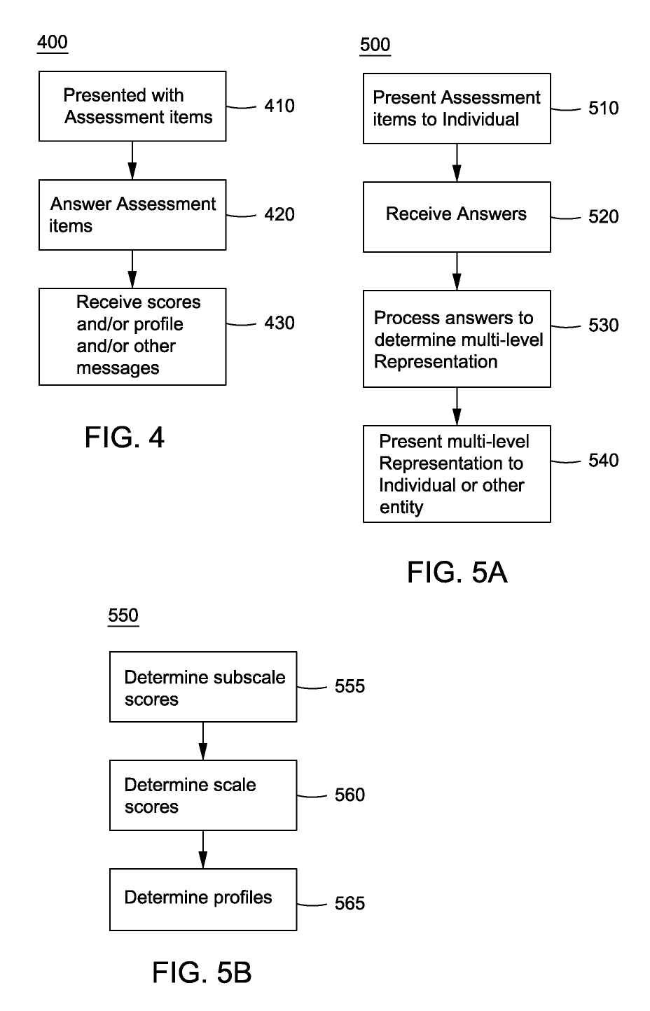

FIG. 4 shows a flowchart 400 of a method of taking an assessment, according to an embodiment. The flowchart 400 is from the perspective of an individual 210 taking the assessment. The individual 210 may take the assessment using any type of computing device (i.e., the user interface 230) that is able to display the assessment items and receive answers through an input device, such as a mouse or keyboard. In some embodiments, the assessment is provided as an online assessment over the Internet or other network.

At 410, the individual 210 is presented with assessment items. These items may be a series of true/false statements as described above, for example. At 420, the individual 210 provides answers to the assessment items. The individual 210 may be presented with items and may provide answers through the user interface 230 shown in FIG. 2.

At 430, the individual 210 is, optionally, presented with scores (e.g., a multi-level representation 100 in the form of a report 280) and a profile 120 as processed by the assessment engine 250 and/or the report engine 270. Depending on the entity for whom the individual 210 is taking the assessment, the individual 210 may see his or her raw scale scores 301, normative percentile ranks 302, subscale scores 310, and/or profile 120. The individual 210 may be presented with a message indicating that the assessment is completed, including, for example, further instructions and/or notices.

FIGS. 5A and 5B are flowcharts 500 and 550 of a method of identifying potentially negative aspects of the interpersonal behavior of an individual 210, according to embodiments. The flowcharts 500 and 550 are from the perspective of a processor implementing the assessment. At 510 in the flowchart 500, assessment items are presented to the individual 210. At 520, answers are received. The answers are those provided by the individual 210 via the user interface 230. At 530, the answers are processed to determine the multi-level representation 100 for the individual 210. At 540, the multi-level representation 100 is provided to the individual 210 or to a client 290, such as the organization on whose behalf the individual 210 takes the assessment. The multi-level representation 100 may be provided in the form of a report 280, such as example reports 300, 340, and 380.

The flowchart 550 provided in FIG. 5B provides details on item 530 of the flowchart 500. At 555, the subscale scores 310 are determined. According to an embodiment, each of the plurality of assessment items corresponds to one of the plurality of subscales 110. To determine each of the plurality of subscale scores 310, for each of the plurality of subscales, the answers to a group of assessment items that correspond to the respective subscale 110 are summed.

At 560, the raw scale scores 301 of each of the scales 101 are determined. For each of the plurality of scales 101, the subscale scores 310 of the respective subset of the plurality of subscales 110 are summed.

According to an embodiment, each of the plurality of answers corresponds to a zero or a one. According to another embodiment, each of the plurality of assessment items comprises a statement to which the individual 210 provides a true/false response. Thus, for example, if the individual 210 provides a positive answer, which may be true or false depending on how the item is phrased, the individual 210 receives a zero or a one for that particular assessment item.

At 565, the applicable profile or profiles 120 are determined. According to an embodiment, this is accomplished by selecting the one or more profiles 120 from a pre-established selection of profiles 120 that are each based on a range of applicable raw scale scores 301 and normative percentile ranks 302 and applicable subscale scores 310. Therefore, as described above, if an individual 210 scores within +/−1 point, for example, of applicable scale scores and subscale scores for a particular profile 120, the individual 210 may be associated with that particular profile 120. A particular profile 120 may be associated with a subset of certain scales 101 and subscales 110.

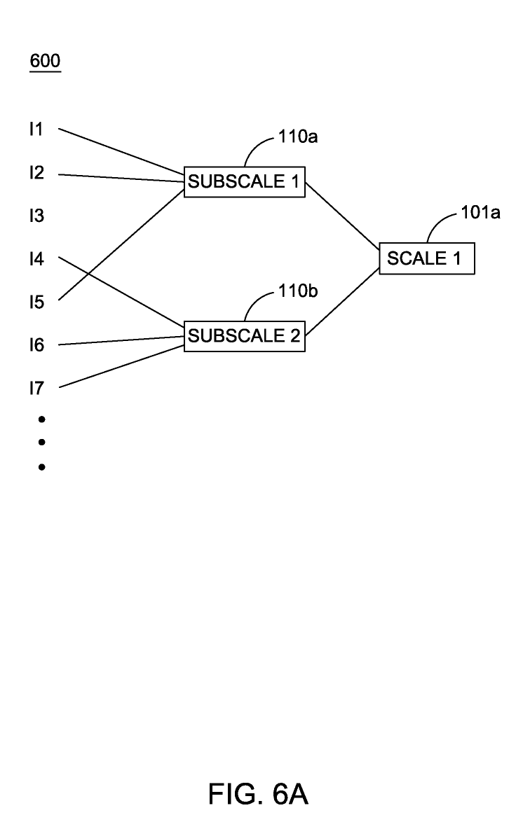

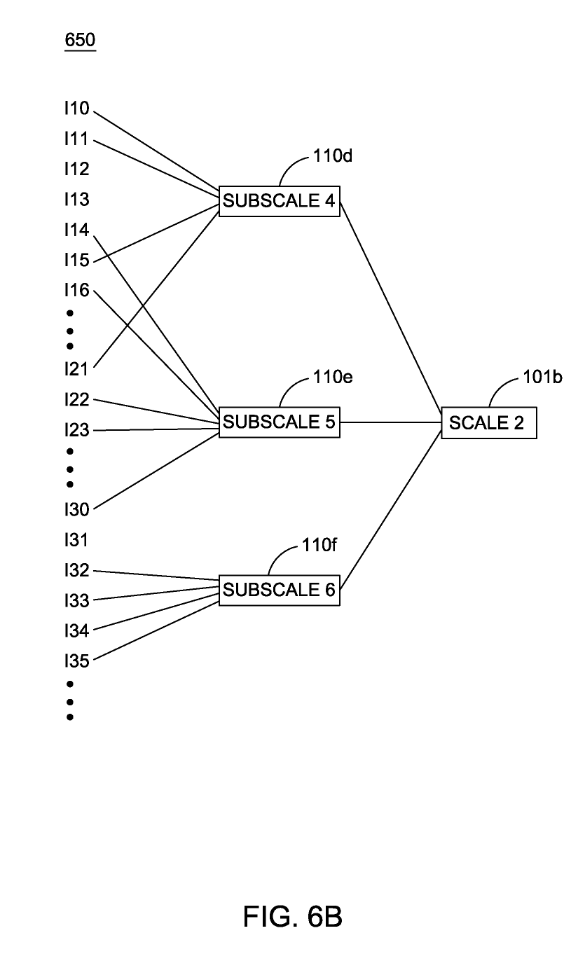

FIGS. 6A and 6B are diagrams 600 and 650, respectively, each illustrating a scoring process used to identify potentially negative aspects of the interpersonal behavior of an individual 210, according to an embodiment. The diagrams 600 and 650 illustrate an example embodiment in which each of the plurality of assessment items corresponds to one of the plurality of subscales 110 and one of the plurality of scales 101. Each assessment item may typically correspond to one subscale; however the invention is not so limited. For example, as shown in FIG. 6A, assessment items I1, I2, and I5 correspond to subscale 1 (110a), and assessment items I4, I6, and I7 correspond to subscale 2 (110b). Thus, to determine the subscale score 310 for subscale 1 (110a), the answers to items I1, I2, and I5 are summed; and for subscale 2 (110b), the answers to items I4, I6, and I7 are summed. If, as shown in this embodiment, subscale 1 (110a) and subscale 2 (110b) are associated with scale 1 (101a), then the raw scale score 301 may be determined by totaling the subscale scores 310 for each of these subscales. Other scoring processes may be implemented, and the diagram 600 is shown as just one such example.

A controller implementing the methods of the flowcharts 500 and 550, including the functionality of the engines, such as the assessment engine 250 and the report engine 270, may be a processing device, computing device, processor, or the like for performing calculations and operations described herein. The controller (i.e., the engines 250 and 270) interface with the item responses 240 via the user interface 230, as well as the data storage 260, and may also interface with one or more memory devices (not shown) such as Read Only Memory (ROM), Random Access Memory (RAM), and one or more optional non-transitory memory devices such as, for example, an external or internal DVD drive, a CD-ROM drive, a hard drive, flash memory, a USB drive, or the like. The memory devices may be configured to include individual files and/or one or more databases for storing any software modules, instructions, or data.

Program instructions, software, or interactive modules for performing any of the functional steps associated with the processes as described above may be stored in the ROM and/or the RAM. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface may permit information from the engines 250 and 270 to be displayed on the user interface 230 or at a client display in audio, visual, graphic, and/or alphanumeric format. Communication with external devices may occur using various communication ports that may be attached to one or more communications networks, such as the Internet or a Local Area Network (LAN), or directly to a portable computing device such as a notebook computer. An interface may allow for receipt of data from input devices such as a keyboard, a mouse, a joystick, a touch screen, a remote control, a pointing device, a video input device, an audio input device, and the like.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. For example, although the invention is primarily described herein with reference to potentially negative aspects of interpersonal behavior, with the potentially negative aspects represented in scales and subscales, other types of aspects may be represented in the scale-subscale structure described herein. It is therefore intended that the appended claims be construed to cover all such equivalent variations as fall within the true spirit and scope of the invention.

We claim:

1. A computer-implemented method of identifying aspects of interpersonal behavior of an individual, the aspects represented in a multi-level representation, the method comprising:
presenting the individual with a plurality of assessment items relating to interpersonal behavior;
receiving a plurality of answers, each answer of the plurality of answers corresponding to one of the plurality of assessment items; and
determining, based on the plurality of answers, a multi-level representation of the interpersonal behavior of the individual, wherein the multi-level representation comprises (i) a plurality of scale scores, each scale score corresponding to a respective one of a plurality of scales; and (ii) a plurality of subscale scores, each subscale score corresponding to a respective one of a plurality of subscales;
wherein each of the plurality of scales describes a respective aspect of interpersonal behavior and comprises a subset of the plurality of subscales that further define the respective aspect of interpersonal behavior.

2. The method of claim 1, wherein the plurality of scale scores and the plurality of subscale scores indicate a propensity of the individual to the respective aspects of interpersonal behavior.

3. The method of claim 1, wherein determining the multi-level representation comprises determining each of the plurality of subscale scores by, for each of the plurality of subscales, summing answers to a subset of the plurality of assessment items that correspond to the respective subscale.

4. The method of claim 3, wherein determining the multi-level representation further comprises determining each of the plurality of scale scores by, for each of the plurality of scales, totaling the plurality of subscale scores of the respective subset of the plurality of subscales.

5. The method of claim 4, wherein each of the plurality of answers corresponds to a zero or a one.

6. The method of claim 1, wherein each of the plurality of assessment items comprises a statement to which the individual provides a true/false response.

7. The method of claim 1, wherein the multi-level representation further comprises one or more profiles, each of the one or more profiles based on the plurality of scale scores and the plurality of subscale scores.

8. The method of claim 7, wherein determining the multi-level representation comprises selecting the one or more profiles from a pre-established selection of profiles, wherein each of the pre-established selection of profiles is based on a range of applicable scale scores and applicable subscale scores.

9. The method of claim 1, wherein each of the plurality of assessment items corresponds to one of the plurality of subscales.

10. A computer-implemented method of implementing an assessment to identify potentially negative aspects of interpersonal behavior of an individual, the method comprising:
presenting the individual with a plurality of assessment items relating to potentially negative interpersonal behavior;
receiving a plurality of answers, each answer of the plurality of answers corresponding to one of the plurality of assessment items; and
determining, based on the plurality of answers: (i) a plurality of subscale scores, each subscale score corresponding to a respective one of a plurality of subscales and comprising a sum of a subset of answers whose respective assessment items correspond to the respective subscale; and (ii) a plurality of scale scores, each scale score corresponding to a respective one of a plurality of scales and comprising a sum of a subset of subscale scores whose respective subscales correspond to the respective scale;
wherein each of the plurality of scales describes a respective potentially negative aspect of interpersonal behavior and comprises a subset of the plurality of subscales that further define the respective potentially negative aspect of interpersonal behavior.

11. The method of claim 10, wherein the plurality of scale scores and the plurality of subscale scores indicate a propensity of the individual to the respective potentially negative aspects of interpersonal behavior.

12. The method of claim 10, further comprising:
selecting, from a pre-established selection of profiles, one or more applicable profiles that correspond to the plurality of subscale scores and the plurality of scale scores.

13. The method of claim 12, wherein each of the pre-established selection of profiles is based on a range of applicable scale scores and applicable subscale scores.

14. The method of claim 12, further comprising:
creating a report to present one or more of the plurality of subscale scores, the plurality of scale scores, and the one or more applicable profiles.

15. A system for implementing an assessment to identify potentially negative aspects of interpersonal behavior of an individual, the system comprising:
an interface to present the individual with a plurality of assessment items relating to potentially negative interpersonal behavior and to receive a plurality of answers, each answer of the plurality of answers corresponding to one of the plurality of assessment items; and
a controller configured to determine, based on the plurality of answers: (i) a plurality of subscale scores, each subscale score corresponding to a respective one of a plurality of subscales and comprising a sum of a subset of answers whose respective assessment items correspond to the respective subscale; and (ii) a plurality of scale scores, each scale score corresponding to a respective one of a plurality of scales and comprising a sum of a subset of subscale scores whose respective subscales correspond to the respective scale;
wherein each of the plurality of scales describes a respective potentially negative aspect of interpersonal behavior and comprises a subset of the plurality of subscales that further define the respective potentially negative aspect of interpersonal behavior.

16. The system of claim 15, wherein the plurality of scale scores and the plurality of subscale scores indicate a propensity of the individual to the respective potentially negative aspects of interpersonal behavior.

17. The system of claim 15, wherein the controller is further configured to select, from a pre-established selection of profiles, one or more applicable profiles that correspond to the plurality of subscale scores and the plurality of scale scores,

18. The system of claim 17, wherein each of the pre-established selection of profiles is based on a range of applicable scale scores and applicable subscale scores.

19. The system of claim 17, wherein the controller is further configured to create a report to present one or more of the plurality of subscale scores, the plurality of scale scores, and the one or more applicable profiles.
